(19) United States
(12) Patent Application Publication
(10) Pub. No.: US 2016/0086474 A1
(43) Pub. Date: Mar. 24, 2016

(54) ELECTRICAL DEVICE EQUIPPED WITH INDICATORS

(71) Applicant: GE Energy Power Conversion Technology Ltd, Warwickshire (GB)

(72) Inventors: Fan ZHANG, Shanghai (CN); Richard S. ZHANG, Shanghai (CN); Rui LI, Shanghai (CN); Lin LAN, Shanghai (CN)

(21) Appl. No.: 14/863,908

(22) Filed: Sep. 24, 2015

(30) Foreign Application Priority Data
Sep. 24, 2014 (CN) 201420552753.9

(51) Int. Cl. G08B 21/18; G08B 5/36

(52) U.S. Cl. CPC G08B 21/18; G08B 5/36

(57) ABSTRACT

An electrical device comprises indicators used to indicate the operating status of the electrical device and/or the presence of hazardous voltage within the electrical device cabinet. The indicators comprise a lighting strip mounted on the outside of the device. The lighting strip can display different colors and/or flash according to the actual status of the electrical device.

### FIELD OF THE INVENTION

Embodiments of the present invention relate to an electrical device equipped with indicators and, more particularly to an electrical device comprising indicators that indicate operating status and/or safe status.

### BACKGROUND OF THE INVENTION

Most electrical devices used in the industrial domain, such as switch boxes, switches, and converters, have indicators of lamps of different colors, such as red to indicate a fault, green to indicate normal operation and red to indicate system alert. Such indicators are monotonous and unchanging, and are neither eye-catching nor visually appealing.

Consequently there may be a need to provide intuitive and eye-catching indicators for electrical devices in the industrial domain to indicate operating status and/or safe status.

### BRIEF DESCRIPTION OF THE INVENTION

Embodiments of the present invention provide a new electrical device indicator to solve the above problems.

In order to achieve this objective, embodiments of the present invention provide an electrical device comprising indicators to indicate the operating status of the device and/or the presence of hazardous voltage within the device cabinet. The indicator comprises a lighting strip mounted on the outside of the device. The lighting strip can display different colors and/or flash according to the actual status of the electrical device.

In embodiments, the strip further comprises LED strips.

Furthermore, in embodiments, the lighting strip can display different colors and/or flash when the electrical device is operating normally and faulty respectively.

Furthermore, in embodiments, the lighting strip can display different colors or/and flash when the electrical device is at high-voltage, operating normally, faulty and has no high voltage.

Furthermore, the lighting strip may be configured to display yellow when the electrical device is at high voltage, display green when it is operating normally, display red when there is a fault, and display blue when there is no high voltage.

Furthermore, in embodiments, the lighting strip can display an image.

Furthermore, in embodiments, the image comprises a product logo.

Furthermore, in an embodiment, the lighting strip is in the shape of a horizontal wave.

Furthermore, in an embodiment, the electrical device comprises three indicator lights of different colors to indicate fault, normality, and system alert respectively.

Furthermore, in an embodiment, the lighting strip comprises a plastic board and an LED strip installed at the edge or bottom of the plastic board. The plastic board has a laser-etched image thereon, and the illumination of the LED strip enhances the image reflection.

The advantage of embodiments of the present invention is that it integrates operating and safety status indicators with industrial designs, by means of using operating and safety status indicators of large area to provide users with intuitive indications. Meanwhile, the indicator can be of any shape for convenient incorporation into the industrial design of products, resulting in more effective and visually appealing displays.

### BRIEF DESCRIPTION OF THE DRAWINGS

The attached drawings are used to illustrate an embodiment of the invention to facilitate understanding of the invention. In the drawings:

FIG. 1 is a schematic diagram of an electrical device indicator of one embodiment of the invention.

FIG. 2 is a schematic diagram of an electrical device indicator of another embodiment of the invention.

### DETAILED DESCRIPTION

Embodiments of the present invention are described in detail below. Unless otherwise specified, the meanings of all technological and scientific terminology used herein are as normally understood by technicians in the technical domain of the invention.

The use of “one” or “a” in the description is not intended to indicate a limited quantity but the existence of at least one of the relevant items. The use of “or” is intended to indicate any one or all of the listed components or items. The use of “include”, “comprise” or a similar term is intended to mean the component or item listed in front of the term “includes” or “comprises” the components or items listed after the term but does not exclude other components or items. The use of “connect”, “link” or similar terms is not limited to physical or mechanical connections but also includes electrical connections, whether direct or indirect.

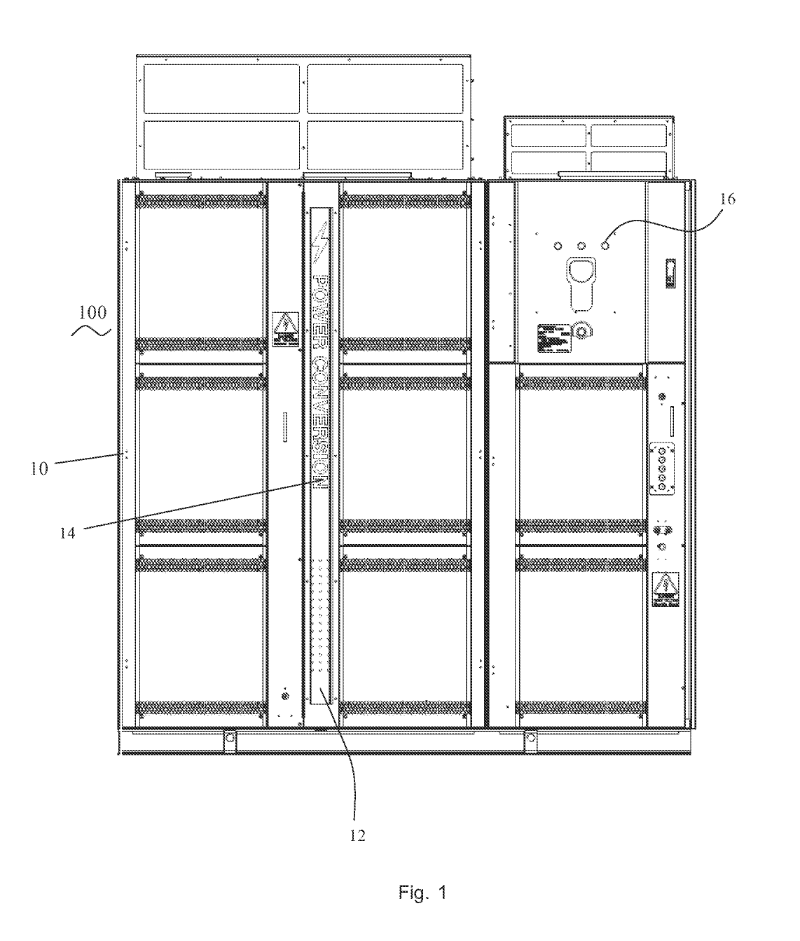

FIG. 1 shows electrical device 100 in one embodiment, such as a distribution box, sub-gate switch or inverter. As shown in FIG. 1, electrical device 100 comprises cabinet 10 and components/parts (not shown) housed therein. The electrical components/parts comprise, but are not limited to, semiconductor components, capacitors, resistors and reactors. An indicator is mounted on the outside of the cabinet, for example in an eye-catching position on the front of the cabinet, to indicate the operating and/or safety status of the electrical device. Detection apparatus is used to measure the voltage inside the cabinet, which is fed to a controller. The controller uses the feedback data to control the indicator to display the corresponding color. The colors displayed can be selected in accordance with relevant safety regulations or standards.

In an embodiment, the indicator comprises at least one lighting strip 12 and the lighting strip 12 displays different colors according to the different operating statuses of the electrical device and the presence of a designated voltage level (e.g., hazardous voltage) in the cabinet. The indicator is connected to the controller (not shown) in electrical device 100, which is used to control the color displayed by the indicator, so that the different running statuses or the presence of hazardous voltage inside the cabinet can be indicated, for example, by at the least displaying different colors when the electrical device is operating normally and when it is faulty respectively. In another embodiment, the indicator comprises lighting strip 12 that can show different colors when electrical device 100 is at high voltage, when it is operating normally, when it is faulty and when it has no high voltage. For example, lighting strip 12 displays yellow when electrical device 100 carries high voltage, lighting strip 12 displays green when electrical device 100 is operating normally, lighting strip 12 displays red when electrical device 100 is faulty and lighting strip 12 displays blue when electrical device 100 has no high voltage. More particularly, the voltage on the DC bus is detected and compared with a safe voltage standard (such as 50V). When the detected voltage is higher than the safe voltage standard, it determines the electrical device is at high voltage status, and controls the lighting strip to display the relevant color to alert the high voltage status, so as to avert electric shock or other danger.

The lighting strip 12 can comprise an LED strip that displays different colors using different combinations of color LEDs, or incorporate flashing to indicate the device status. In the embodiment shown in FIG. 1, the lighting strip 12 extends in the longitude direction of electrical device 100 and covers most of its longitudinal dimension. In some implementations, the lighting strip 12 can display image 14 and the image can comprise a product logo. As shown in FIG. 1, LED strip 12 is used with surface image 14 to display a product logo or a combination of letters. In an embodiment, the lighting strip 12 comprises a plastic board (such as perspex sheet) and an LED strip located at the edge or bottom thereof. The plastic board incorporates a laser-etched product logo or similar image. The illumination of the LED strip enhances the image reflection.

In some embodiments, the electrical device 100 can comprise indicator marks 16 in 3 different color lamps, indicating fault, normal operation and system alert, respectively. In an embodiment, the 3 colors are red, green and yellow. The red lamp is lit to indicate a fault in electrical device 100, the green lamp is lit to indicate normal operation of electrical device 100 and the yellow lamp is lit to indicate system alert of electrical device 100. Generally, system alert means the electrical device is running with parameters out of a specified range but has not reached fault status.

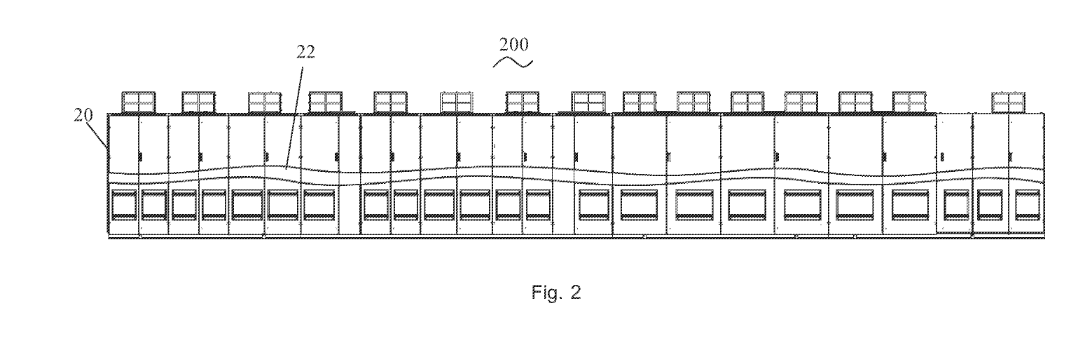

FIG. 2 illustrates electrical device 200 of another embodiment. Similar to electronic device 100, the electrical device 200 comprises cabinet 20 and electrical components (not shown) housed inside cabinet 20. An indicator is located at an eye-catching location on the outside of cabinet 20 to indicate the operating status of the electrical device. However, lighting strip 22 of the indicator on electrical device 200 is in the shape of a horizontal wave that spans the whole horizontal dimension of electrical device 200. Similar to lighting strip 12, the lighting strip 22 can also show different colors for different statuses of electrical device 200, such as when at high voltage, when operating normally, when faulty and when there is no high voltage. In addition, electrical device 200 can further include or not include indications in different color lamps to indicate fault, normal operation and system alert.

The display colors of the lighting strips 12 or 22 are not limited to the above examples and can be designed or customized according to specific requirements. Additionally, the lighting strip can be in any shape. A large-area lighting strip can be designed to integrate with the industrial design of an electrical device, to achieve an intuitive and eye-catching effect. In some embodiments, the lighting strip spans a certain proportion (such as 50% or 70%) of the horizontal or longitude dimension of the electrical device.

It should be pointed out that the lighting strip is intended to indicate the operating and safety statuses of electrical devices as an auxiliary measure, while the actual operating or safety status of the electrical device should be confirmed according to the specified series of operations for the electrical device.

This invention can be summarized using other specific formats that do not violate the principles or key features of this invention. Consequently, the above embodiments can be regarded as descriptive of this invention and not limiting thereof in any way. The scope of this invention shall be defined by the claims thereof instead of the above embodiments. Consequently any change to the meaning and scope of the claims of this invention shall be deemed to be included within the scope of the claims.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An electrical device, comprising:
a status indicator for indicating an operation status of the electrical device and/or if there is a designated voltage level in a cabinet of the electrical device, wherein the status indicator comprises a light bar disposed on an exterior of the electrical device, the light bar configured to display different colors and/or blink in response to different operation statuses of the electrical device.

2. The electrical device according to claim 1, wherein the light bar comprises a LED panel.

3. The electrical device according to claim 1, wherein the light bar is configured to display two different colors and/or blink in response to a normal operation status and a fault status, respectively.

4. The electrical device according to claim 1, wherein the light bar is configured to display different colors and/or blink in response to an energized status, a normal operation status, a fault status, and a not-energized status, respectively.

5. The electrical device according to claim 4, wherein the light bar is configured to display yellow, green, red and blue in response to an energized status, a normal operation status, a fault status, and a not-energized status, respectively.

6. The electrical device according to claim 1, wherein the light bar is configured to display an image.

7. The electrical device according to claim 6, wherein the image comprises a product mark.

8. The electrical device according to claim 1, wherein the light bar comprises a horizontal wave shape strip.

9. The electrical device according to claim 1, further comprising three lamps of different colors, which indicate that there is a fault, the electrical device is in a normal operation status, and there is a system warning, respectively.

10. The electrical device according to claim 1, wherein the light bar comprises a plastic plate and a LED panel mounted around an edge of the plastic plate or at a bottom of the plastic plate, the plastic plate comprising a laser-engraved image and the LED panel capable of strengthening a reflection effect of the image by illuminating the image.
